(19) United States
(12) Patent Application Publication
(10) Pub. No.: US 2014/0322509 A1
(43) Pub. Date: Oct. 30, 2014

(54) MULTI-LAYER BODIES MADE OF POLYCARBONATE WITH A DEEP GLOSS EFFECT

(71) Applicant: Bayer Intellectual Property GmbH, Monheim (DE)

(72) Inventors: Alexander Meyer, Dusseldorf (DE); Jörg Reichenauer, Krefeld (DE); Peter Capellen, Krefeld (DE)

(73) Assignee: Bayer Intellectual Property GmbH, Monheim (DE)

(21) Appl. No.: 14/359,317

(22) PCT Filed: Nov. 27, 2012
(86) PCT No.: PCT/EP2012/073712

§ 371 Date: May 20, 2014

(30) Foreign Application Priority Data
Nov. 30, 2011 (EP) 11191314.1

(51) Int. Cl. B60J 10/00

(52) U.S. Cl. CPC B60J 10/0005
USPC 428/216; 428/336; 427/402; 264/129

(57) ABSTRACT

The present invention relates to dark multilayer bodies made from polycarbonate, which are characterised by a glass-like deep-gloss effect on the surface. The invention also relates to a method for producing these multilayer bodies. The multilayer bodies are preferably synthesised from polycarbonate or polycarbonate blends. The polycarbonate blends can contain further polymers such as for example elastomers or graft polymers, or further thermoplastics such as polyesters for example. The invention also relates to the use of the multilayer bodies according to the invention as panels for vehicle parts or as frame parts for multimedia housings.

The present invention relates to dark multilayer bodies made from polycarbonate, which are characterised by a glass-like deep-gloss effect on the surface. The invention also relates to a method for producing these multilayer bodies.

The multilayer bodies are preferably synthesised from polycarbonate or polycarbonate blends. The polycarbonate blends can contain further polymers such as for example elastomers or graft polymers, or further thermoplastics such as polyesters for example.

The invention also relates to the use of the multilayer bodies according to the invention as panels for vehicle parts or as frame parts for multimedia housings.

Until now there has been a lack of multilayer systems, in particular multilayer plastic moulded parts, made from polycarbonate that are characterised by a glass-like appearance. These multilayer bodies are suitable in particular for exterior vehicle parts. They must have an excellent surface quality, a deep gloss effect and excellent weathering resistance. Applications include inter alia frame parts for glazing products made from glass, such as for example sunroofs. Owing to the long service life of motor vehicles it is important that the desired high-quality colour impression—in this case the particularly black deep-gloss effect—of the material is retained over the life of the vehicle with no appreciable deterioration, particularly in the prestige automobile sector.

These multilayer bodies offer many advantages over conventional materials such as glass, for example, for use in the automotive sector. These advantages include for example increased break resistance and/or weight savings, which in cars allow for greater occupant safety in road traffic accidents and lower fuel consumption. Finally, materials containing thermoplastic polymers offer substantially more design freedom because they are easier to mould.

Exterior vehicle parts for use in the automotive, railway, aircraft and infrastructure sectors also have to have a long service life and must not become brittle during that time. Moreover, there should be little or no change in the colour and gloss effect over the life of the part. In addition, the thermoplastic parts should have adequate scratch resistance.

In view of the long required service life and given its high surface quality and deep-gloss effect, glass is frequently used as a material. Glass is unaffected by UV radiation, is resistant to scratching and undergoes no change in mechanical properties over extended periods of time. As inorganic oxides such as iron oxide for example are used as pigments, there is virtually no change in the colour properties even over extended periods of time. These pigments cannot be used in thermoplastic materials, however, as they lead to degradation of the corresponding matrix.

Nevertheless, in view of the advantages of plastics as described above, there is a need for materials that offer both the good physical properties of thermoplastics and the high surface quality and desired deep-gloss effect of correspondingly black-pigmented glass.

Of the transparent thermoplastics, polymers based for example on polycarbonate and polymethyl methacrylate (PMMA) are particularly suitable for use as exterior parts for automotive applications. Owing to its high toughness, polycarbonate in particular has a very good range of properties for such applications.

To improve the longevity of thermoplastic materials, the addition of UV protection and/or scratch-resistant coatings is known. Furthermore, a large number of colouring agents having high lightfastness are known.

It has been found, however, that the thermoplastic compositions mentioned in the prior art are only inadequately suitable when exceptionally high weathering resistance combined with high surface quality, a high deep-gloss effect and a piano lacquer appearance are required. For deep black components with a piano lacquer-like surface for exterior applications in particular, the prior art offers no possible solutions.

In the prior art, black or dark exterior parts are often pigmented with carbon black in order to obtain the desired black impression. However, the use of carbon black is problematic as it can lead to surface defects. Owing to its small particle size, nanoscale carbon black should not in fact influence the surface, but agglomerates form very easily which then in turn lead to surface defects. These surface defects are visible to the eye. Furthermore, however, these surface defects constitute defect sites for subsequent coatings, such that the paint at these points is prone to delamination, cracking, etc., under weathering. For that reason a high surface quality with as few defect sites as possible is highly advantageous, on both optical and technical grounds. Frequently also the attempt is made to introduce carbon black into the thermoplastic matrix in the form of a dispersion. However, these dispersing agents are often functionalised in order to hold the inorganic particles in dispersion, though the functional groups damage the thermoplastic matrix, in particular the polycarbonate matrix, and are therefore undesirable.

If carbon black is used as a pigmenting agent, injection moulded articles often lack a deep-gloss effect and instead appear dull and sometimes slightly yellowish because of the absorption spectrum of carbon. By contrast, with very low carbon black concentrations the deep black impression is lost.

A high-gloss surface can also be achieved using nanoscale or fine-particle carbon modifications such as carbon nanotubes, for example, as described in WO 2009030357, or graphite, as demonstrated in JP 2003073557. However, the rod-like or platelet-like shape of the particles gives the injection moulded part a certain surface roughness, which is undesirable.

To avoid the aforementioned disadvantages associated with carbon black or other carbon modifications, soluble dyes are frequently used to achieve a high surface gloss—a kind of piano lacquer appearance. The disadvantage of this solution, however, is that the dyes have to be used in a relatively high concentration. This leads to problems in the lacquering process, since dyes present in high concentration easily leach out of the surface of the moulded part due to the paint solvents. This gradually colours the lacquering solution. In the industrial lacquering process the lacquer solution is frequently circulated in order to economise on lacquer solution. However, the moulded parts are thus gradually lacquered with a coloured lacquer solution, which is undesirable. The lacquer should remain colourless so as not to adversely affect the deep-gloss appearance. In addition, different components are lacquered with the same lacquer solution on large industrial lacquering lines. This inevitably causes problems with transparent components or components of a specific colour in particular. It should be emphasised at this point that low-pigmented but still dark colours, such as privacy colours for example, which still have a degree of transparency, use significantly lower dye concentrations. In such cases bleeding of the plastic surface does not cause the lacquering solution to become coloured. A further disadvantage of using organic dyes is fading due to UV radiation, causing the colour impression to change over time. Certain colour settings that are used for exterior automotive parts that also use dyes are described for example in JP 11106518.

The object was therefore to develop a black finished part having a light transmission of less than 1.0%, preferably less than 0.5%, more preferably less than 0.2%, still more preferably less than 0.1% and particularly preferably 0.0%, from a thermoplastic material—preferably a polycarbonate—which combines excellent surface quality and high deep-gloss, a piano lacquer-like black impression and high weathering resistance and which is suitable for frame parts in the automotive sector or for multimedia housings, such as for example television frames or similar, which are exposed to UV radiation.

In addition, the composition according to the invention should not have the yellowish colour impression of carbon black-filled types. The material according to the invention exhibits little or no bleeding during the lacquering of injection moulded parts made from said material with lacquers that are suitable for polycarbonate, such that little or no colouring occurs of the excess lacquer solution that is recirculated, allowing it to be used for longer without resulting in colour errors.

Ketones and alcohols and mixtures thereof with one another and also in combination with water are used as paint solvents for polycarbonate primer or lacquer solutions. Diacetone alcohol (4-hydroxy-4-methylpentan-2-one), 1-methoxy-2-propanol, butanol, isopropanol or mixtures of these solvents and most particularly preferably diacetone alcohol (4-hydroxy-4-methylpentan-2-one), 1-methoxy-2-propanol or mixtures of these solvents are preferably used.

The object of the present invention was moreover to provide multilayer bodies having only a very small number of surface defects.

The multilayer bodies according to the invention are suitable for example for black panels intended for exterior applications in the automotive sector. These panels can incorporate or frame glass elements such as windows or sunroofs, for example. The black deep-gloss appearance has the effect of increasing the apparent size of the glazing area, since the roof, such as a panoramic roof for example, appears to be made entirely from glass. Decorative panels can also be made from this material. Furthermore, connecting pieces which visually link glass units are included. The same applies to connecting pieces between A and B pillars in the automotive sector. Reinforcing ribs, mounting aids and regions to receive the adhesive bead are optionally injection-moulded to the frame to allow for corresponding ease of assembly. Furthermore, a special shaping, such as a special 3-dimensional shape, can be present. As the frames are relatively large and have a complex geometry, the thermoplastic material must have sufficient flowability to enable it to be processed into corresponding mouldings in the injection moulding process, such as especially the injection-compression moulding process, for example.

The material is also suitable for frames or housings as used in the electrical or multimedia sector. Examples would include television frames, laptop housings, lamp covers, etc.

A further object of the present invention was to provide a method for producing thermoplastic multilayer bodies having the aforementioned properties.

Surprisingly, the object was able to be achieved with special multilayer plastic moulded parts containing a substrate material comprising special colouring agents and having a UV—and scratch-resistant coating. It was found that only very specific mixtures of colouring agents in combination with a transparent lacquer layer are suitable for achieving the desired deep-gloss effect and the desired colour stability with a low tendency to bleed.

The underlying objects are achieved by the thermoplastic polymer compositions according to the invention and multilayer systems having a UV- and scratch-resistant coating produced by a method according to the invention.

The multilayer body according to the invention comprises:
1) a base layer having a light transmission of less than 1.0%, preferably less than 0.5%, more preferably less than 0.2%, still more preferably less than 0.1% and particularly preferably 0.0%, containing
1.1) at least one thermoplastic, preferably polycarbonate, more preferably having a melt volume-flow rate of
   i. 6 cm³/(10 min) to 25 cm³/(10 min),
   ii. preferably 9 to 21 cm³/(10 min), in accordance with ISO 1133 (at 300° C. under a 1.2 kg load),
1.2) at least one colouring agent selected from the following structures

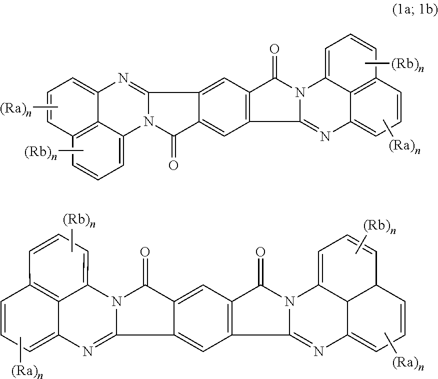

in which
   R^{a} and R^{b} independently of each other denote a linear or branched alkyl radical, or halogen, preferably methyl, ethyl, propyl, isopropyl, butyl, isobutyl, tert-butyl, pentyl, neopentyl, hexyl, thexyl or C1, more preferably methyl, C1 and particularly preferably C1,
   n independently of each R denotes a natural number between 0 and 3, the radical being hydrogen in the case of n=0.

In a preferred embodiment Ra and/or Rb are C1 and are located in the o- and/or p-positions to the carbon atoms bearing the amine functionalities, such as for example di-ortho-chloronapthaleno, di-ortho, mono-para-chloronaphthaleno and mono-ortho-naphthaleno. Moreover in a preferred embodiment Ra and Rb each represent a tert-butyl radical, which is preferably located in the meta-position to the carbon atoms bearing the nitrogen functionalities.

In a particularly preferred embodiment n=0 in all rings, such that all Ra and Rb are H.

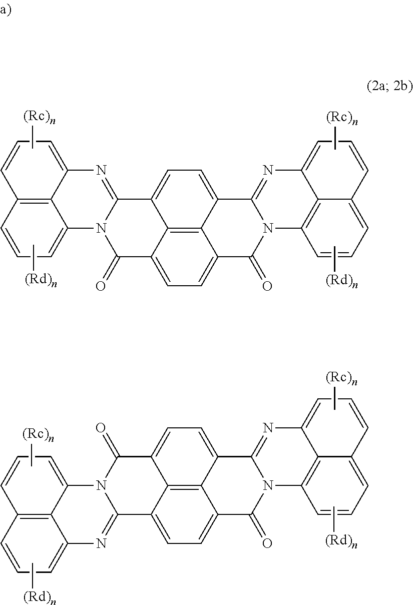

in which
Rc and Rd independently of each other denote a linear or branched alkyl radical, or halogen, preferably methyl, ethyl, propyl, isopropyl, butyl, isobutyl, tert-butyl, pentyl, neopentyl, hexyl, thexyl or C1, more preferably methyl, C1 and particularly preferably C1, and
n independently of each R denotes a natural number between 0 and 3, the radical being hydrogen in the case of n=0.

In a preferred embodiment Rc and/or Rd are C1 and are located in the o- and/or p-positions to the carbon atoms bearing the amine functionalities, such as for example di-ortho-chloronapthaleno, di-ortho, mono-para-chloronaphthaleno and mono-ortho-naphthaleno. Moreover in a preferred embodiment Rc and Rd each represent a tert-butyl radical, which is preferably located in the meta-position to the carbon atoms bearing the nitrogen functionalities.

In a particularly preferred embodiment n=0 in all rings, such that all Rc and Rd are H.

Structures (1a) and (1b) and (2a) and (2b) relate isomerically to one another. The individual isomers can be used on their own or in a mixture. In one particular embodiment a 1:1 mixture of isomers (relative to the amount of isomer in the mixture of isomers in wt. %) of (1a) and (1b) or (2a) and (2b) is used.

The production of such colouring agents has been described for example in DE 2148101 or WO 2009 074504 A1.

In a further embodiment structures (1a), (1b), (2a) and (2b) are each used as pure isomers, wherein the pure isomers can be obtained for example by preparative HPLC.

In a particular embodiment a combination of colouring agents of structures (1a), (1b), (2a) and (2b) is used.

These combinations are preferably used in concentrations from 0.01 wt. % to 0.50 wt. %, preferably from 0.02 wt. % to 0.30 wt. % and particularly preferably from 0.03 wt. % to 0.25 wt. %.

If the colouring agents of structures (1a), (1b), (2a) and (2b) are used individually, these colouring agents are each used in concentrations from 0.05 wt. % to 0.50 wt. %, preferably from 0.10 wt. % to 0.30 wt. %.
1.3) optionally nanoscale carbon black in a concentration of less than 0.03 wt. %, more preferably less than 0.025 wt. %, still more preferably less than 0.02 wt. %.
   The composition is particularly preferably free from carbon black.
1.4) optionally one or more colouring agents of the following structures:

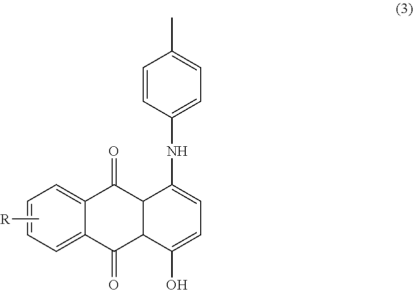

R is selected from the group consisting of H and p-methyl phenylamine radical; preferably R═H.
Such colouring agents are available for example under the trade name Macrolex® Violet B from Lanxess AG. In a particularly preferred embodiment no colouring agent of structure (3) is used.

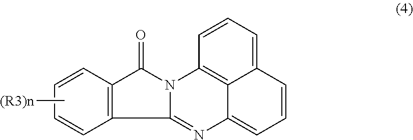

in which R3 preferably denotes halogen and in particular preferably C1, wherein particularly preferably n=4. An embodiment with n=0, such that R3=H, is more preferred.

Such colouring agents are available for example under the names Macrolex® Orange 3G or Macrolex® Red EG from Lanxess AG.

If R3 denotes C1 and n=4, then in place of the colouring agent of structure (4) the colouring agent of structure (5) can be used to achieve the same colour properties:

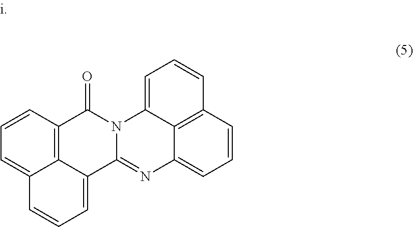 [SMILES: O=c1c2cccc3cccc(c32)c2nc3cccc4cccc(c43)n12]

Such colouring agents are available for example under the trade name Macrolex® Red E2G from Lanxess AG.

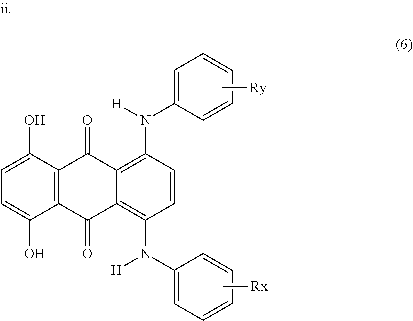

in which R^{x} and R^{y} denote a branched or linear alkyl radical. In particular a linear or branched C1 to C12 radical and particularly preferably a methyl, ethyl, propyl, n-butyl, isopropyl, isobutyl, tert-butyl, pentyl, hexyl, heptyl, octyl radical and most particularly preferably n-butyl, tert-butyl and methyl. Such colouring agents are available for example under the trade name Macrolex® Green G (e.g. CAS no. 28198-05-2, 4851-50-7) from Lanxess AG.

In the present invention the designation C(number) (e.g. C1, C12) denotes a carbon chain having a chain length corresponding to the adjacent (number), with structural isomers also being included.

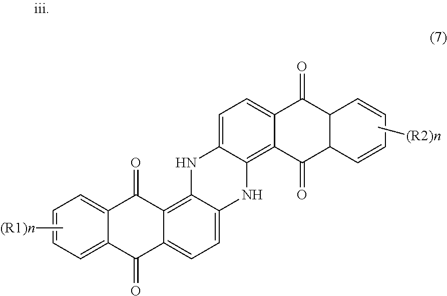

in which
R1 and R2 independently of each other denote a linear or branched alkyl radical, or halogen, preferably methyl, ethyl, propyl, isopropyl, butyl, isobutyl, tert-butyl, pentyl, neopentyl, hexyl, thexyl or C1, more preferably methyl, C1 and particularly preferably C1.
n denotes a natural number between 0 and 4.

In a particularly preferred embodiment n=0 in all rings, such that all R1 and

R2 are H.

Colouring agents of this structure (7) are available commercially in the Paliogen Blue range from BASF AG.

If colouring agents of structure (7) are used, pigments are preferred in particular which have a bulk volume (determined in accordance with DIN ISO 787-11) from 2 l/kg to 10 l/kg, preferably 3 l/kg to 8 l/kg, a specific surface area (determined in accordance with DIN 66132) from 5 m²/g to 60 m²/g, preferably 10 m²/g to 55 m²/g, and a pH (determined in accordance with DIN ISO 787-9) from 4 to 9.

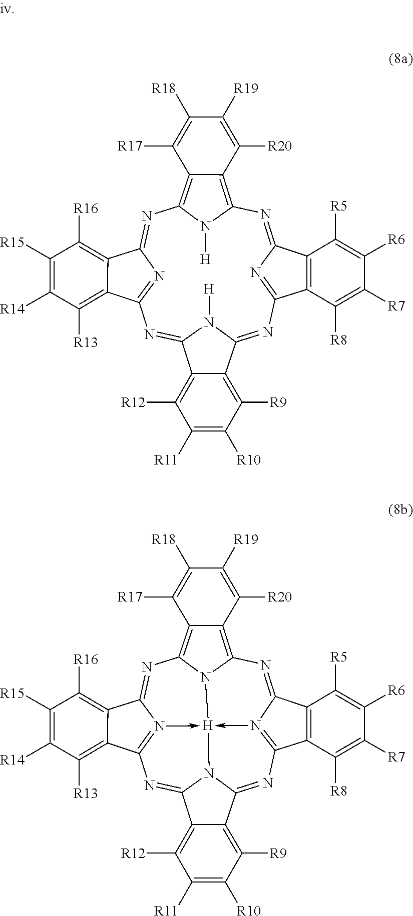

The radicals R(5-20) are in each case independently of one another hydrogen, methyl, ethyl, propyl, isopropyl, butyl, isobutyl, tert-butyl, pentyl, neopentyl, hexyl, thexyl, fluorine, chlorine, bromine, sulfone, CN.

R(5-20) is preferably identical in all positions. R(5-20) is more preferably H in all positions. In an alternative embodiment R(5-20) is C1 in all positions.

M is preferably aluminium (with R═H: aluminium phthalocyanine, CAS: 14154-42-8), nickel (with R═H: nickel phthalocyanine, CAS: 14055-02-8), cobalt (with R═H: cobalt phthalocyanine, CAS: 3317-67-7), iron (with R═H: iron phthalocyanine, CAS: 132-16-1), zinc (with R═H: zinc phthalocyanine, CAS: 14320-04-08), copper (with R═H: copper phthalocyanine, CAS: 147-14-8; with R═H and C1: polychloro copper phthalocyanine, CAS: 1328-53-6; with R═C1: hexadecachlorophthalocyanine, CAS: 28888-81-5; with R=Br: hexadecabromophthalocyanine, CAS: 28746-04-5), manganese (with R═H: manganese phthalocyanine, CAS: 14325-24-7).

The combination of M=Cu and R═H for all positions is preferred in particular. A compound of structure (8b) with M=Cu and R(5-20)=H is available from BASF AG, Ludwigshafen as Heliogen® Blue K 6911D or Heliogen® Blue K 7104 KW.

Compounds of structure (8a) are available from BASF AG, Ludwigshafen as for example Heliogen® Blue L 7460.

These colouring agents can be used in amounts from 0.001 wt. % to 0.050 wt. %, relative to the individual component. These colouring agents are preferably used in lower concentrations than the colouring agents (1a) and (1b) or (2a) and (2b).

More preferably the use of the colouring agents leads to no significant colouring of the lacquer solution, i.e. the measured colour change of the lacquer solution (yellowness index (YI) determined for light type D 65 and 10° standard observer by measuring the colour coordinates (CIE) and calculated in accordance with ASTM E313) is less than |15| (value 15), measured after an extraction time of 270 minutes at room temperature, determined on granules.
1.5) optionally 0.0 wt. % to 1.0 wt. %, preferably 0.01 wt. % to 0.50 wt. %, particularly preferably 0.01 wt. % to 0.40 wt. % of one or more release agents, relative to the total amount of release agents.
1.6) optionally 0.0 wt. % to 20.00 wt. %, preferably from 0.05 wt. % to 10.00 wt. %, more preferably from 0.10 wt. % to 1.00 wt. %, still more preferably 0.10 wt. % to 0.50 wt. % and most particularly preferably 0.10 wt. % to 0.30 wt. % of at least one or more UV absorbers, relative to the total amount of UV absorbers.
1.7) optionally 0.00 wt. % to 0.20 wt. %, preferably 0.01 wt. % to 0.10 wt. % of one or more heat stabilisers or process stabilisers, relative to the total amount of heat stabilisers or process stabilisers, preferably selected from the group of phosphines, phosphites and phenolic antioxidants as well as mixtures thereof. In a special embodiment of the present invention 0.01 wt. % to 0.05 wt. %, preferably 0.015 wt. % to 0.040 wt. % of heat stabilisers or process stabilisers are used.
1.8) optionally 0.0 wt. % to 5.0 wt. %, preferably 0.01 wt. % to 1.00 wt. % of one or more further additives, relative to the total amount of additives.

The amounts specified above relate in each case to the total polymer composition of the base layer, wherein the amount of thermoplastics adds up to 100%.

In a particularly preferred embodiment the base layer consists only of the aforementioned components.
2) At least on one side of the base layer a
   a) polysiloxane-based scratch-resistant coating containing
      i. at least one UV absorber,
         in which
      ii. the thickness of the scratch-resistant layer is from 2 to 15 μm, in particular preferably from 4.0 to 12.0 μm.
3) optionally, in a particular embodiment, at least one adhesion-promoting layer (primer layer) arranged on the base layer between the base layer and the scratch-resistant layer and containing
   i. UV stabiliser,
      wherein
   ii. the thickness of the primer layer is 0.3 to 8 μm, in particular preferably 1.1 to 4.0 μm.

In a further preferred embodiment an adhesion-promoting layer and a scratch-resistant layer are applied to both sides of the base layer.

The appearance of depth is achieved by a multilayer body containing a substrate layer which contains the combination according to the invention of dyes and having a primer layer of a specific thickness and a scratch-resistant layer of polysiloxane lacquer. Only the combination of these components and properties makes it possible to achieve such an effect.

The thermoplastic component of base layer 1.1) consists of:

a thermoplastic, preferably transparent thermoplastic polymer, preferably polycarbonate, copolycarbonate, polyester carbonate, polystyrene, styrene copolymers, aromatic polyesters such as polyethylene terephthalate (PET), PET-cyclohexane dimethanol copolymer (PETG), polyethylene naphthalate (PEN), polybutylene terephthalate (PBT), cyclic polyolefin, poly- or copolyacrylates and poly- or copolymethacrylate such as for example poly- or copolymethyl methacrylates (such as PMMA) as well as copolymers with styrene such as for example transparent polystyrene acrylonitrile (PSAN), thermoplastic polyurethanes, polymers based on cyclic olefins (e.g. TOPAS®, a commercial product from Ticona), more preferably polycarbonate, copolycarbonate, polyester carbonate, aromatic polyesters or polymethyl methacrylate, or mixtures of the specified components, and particularly preferably polycarbonate and copolycarbonate, wherein the transparent thermoplastic polymer is added in an amount such that it together with all other components adds up to 100 wt. %.

Mixtures of a plurality of transparent thermoplastic polymers are also possible, in particular if they are transparently miscible with one another, wherein in a special embodiment a mixture of polycarbonate with PMMA (more preferably with PMMA <2 wt. %) or polyester is preferred.

Suitable polycarbonates for producing the plastic composition according to the invention are all known polycarbonates. These are homopolycarbonates, copolycarbonates and thermoplastic polyester carbonates.

Rubber-modified vinyl (co)polymers and/or further elastomers are also suitable as blend components.

The suitable polycarbonates preferably have average molecular weights Mw from 10,000 to 50,000, preferably from 14,000 to 40,000 and in particular from 16,000 to 32,000, determined by gel permeation chromatography with polycarbonate calibration. The polycarbonates are preferably produced by the interfacial polycondensation process or the melt interesterification process, which are variously described in the literature.

Regarding the interfacial polycondensation process, reference is made by way of example to H. Schnell, “Chemistry and Physics of Polycarbonates”, Polymer Reviews, Vol. 9, Interscience Publishers, New York 1964 p. 33 ff. and to Polymer Reviews, Vol. 10, “Condensation Polymers by Interfacial and Solution Methods”, Paul W. Morgan, Interscience Publishers, New York 1965, chapter VIII, p. 325, to Drs. U. Grigo, K. Kircher and P. R. Müller “Polycarbonate” in Becker/Braun, Kunststoff-Handbuch, Vol. 3/1, Polycarbonate, Polyacetale, Polyester, Celluloseester, Carl Hanser Verlag Munich, Vienna 1992, p. 118-145, and to EP 0 517 044 A1.

The melt interesterification process is described for example in Encyclopedia of Polymer Science, Vol. 10 (1969), Chemistry and Physics of Polycarbonates, Polymer Reviews, H. Schnell, Vol. 9, John Wiley and Sons, Inc. (1964) and in the patents DE-B 10 31 512 and U.S. Pat. No. B 6,228,973.

The polycarbonates are preferably prepared by reacting bisphenol compounds with carbonic acid compounds, in particular phosgene, or, in the melt interesterification process, diphenyl carbonate or dimethyl carbonate.

Homopolycarbonates based on bisphenol A and copolycarbonates based on the monomers bisphenol A and 1,1-bis-(4-hydroxyphenyl)-3,3,5-trimethylcyclohexane are particularly preferred.

These and other bisphenol or diol compounds that are suitable for use in polycarbonate synthesis are disclosed inter alia in WO 2008037364 A1 (p. 7, line 21 to p. 10, line 5), EP 1 582 549 A1 ([0018] to [0034]), WO 2002026862 A1 (p. 2, line 20 to p. 5, line 14), WO 2005113639 A1 (p. 2, line 1 to p. 7, line 20).

The polycarbonates can be linear or branched. Mixtures of branched and unbranched polycarbonates can also be used.

Suitable branching agents for polycarbonates are known from the literature and are described for example in the patents U.S. Pat. No. B 4,185,009 and DE 25 00 092 A1 (3,3-bis-(4-hydroxyaryl oxindoles according to the invention, see the complete document in each case), DE 42 40 313 A1 (see p. 3, lines 33 to 55), DE 19 943 642 A1 (see p. 5, lines 25 to 34) and U.S. Pat. No. B 5,367,044 and the literature cited therein.

The polycarbonates that are used can moreover also be intrinsically branched, in which case no branching agent is added during polycarbonate production. Fries structures, such as are disclosed for melt polycarbonates in EP 1 506 249 A1, are one example of intrinsic branching.

Chain terminators can also be used in polycarbonate production. Phenols such as phenol, alkyl phenols such as cresol and 4-tert-butyl phenol, chlorophenol, bromophenol, cumyl phenol or mixtures thereof are preferably used as chain terminators.

Component 1.3) of the Base Layer

The carbon black is preferably finely dispersed in the organic polymer matrix, without the use of dispersing agents containing functional groups. Suitable carbon blacks have an average particle size of preferably less than 100 nanometres (nm), more preferably less than 75 nm, still more preferably less than 50 nm and particularly preferably less than 40 nm, the average particle size being preferably greater than 0.5 nm, more preferably greater than 1 nm and particularly preferably greater than 5 nm.

Suitable carbon blacks within the meaning of the invention differ from conductive carbon blacks in that they have little or no electrical conductivity. In comparison to the carbon blacks used here, conductive carbon blacks have specific morphologies and superstructures in order to achieve a high conductivity. By contrast, the nanoscale carbon blacks used here can be dispersed very well in thermoplastics, such that virtually no contiguous regions of carbon black occur which could lead to a corresponding conductivity. Commercially available carbon blacks that are suitable within the meaning of the invention are available under many trade names and in many forms, such as pellets or powders. For instance, suitable carbon blacks are available under the trade name BLACK PEARLS®, as wet-processed pellets under the names ELFTEX®, REGAL® and CSX®, and in a flaked form under the names MONARCH®, ELFTEX®, REGAL® and MOGUL®—all available from Cabot Corporation.

In a particularly preferred embodiment the carbon black types have particle sizes from 10 nm to 30 nm and a surface area of preferably 35 m²-138 m² per g (m²/g). The carbon black can be treated or untreated—thus the carbon black can be treated with specific gases, with silica or with organic substances such as butyl lithium, for example. The surface can be modified or functionalised by means of a treatment of this type. This can promote compatibility with the correspondingly used matrix. Carbon backs sold under the trade name BLACK PEARLS® (CAS no. 1333-86-4) are preferred in particular.

Component 1.5)

In the context of the present invention release agents based on a fatty acid ester, preferably a stearic acid ester, more preferably based on pentaerythritol, are used.

If present, the optional release agents are preferably used in a concentration from 0.1 to 0.5 wt. %, in particular preferably from 0.2 to 0.45 wt. %.

In one embodiment pentaerythritol tetrastearate (PETS) or glycerol monostearate (GMS) is particularly preferably used.

Component 1.6)

Suitable ultraviolet absorbers (UV absorbers) are compounds having as low as possible a transmission below 400 nm and as high as possible a transmission above 400 nm. Such compounds and the production thereof are known from the literature and are described for example in EP-A 0 839 623, WO-A 96/15102 and EP-A 0 500 496. Particularly suitable ultraviolet absorbers for use in the composition according to the invention are benzotriazoles, triazines, benzophenones and/or arylated cyanoacrylates.

Particularly suitable ultraviolet absorbers are hydroxy benzotriazoles, such as 2-(3′,5′-bis-(1,1-dimethylbenzyl)-2′-hydroxyphenyl)benzotriazole (Tinuvin® 234, Ciba Spezialitatenchemie, Basel), 2-(2′-hydroxy-5′-(tert-octyl)phenyebenzotriazole (Tinuvin® 329, Ciba Spezialitatenchemie, Basel), 2-(2′-hydroxy-3′-(2-butyl)-5′-(tert-butyl)phenyebenzotriazole (Tinuvin® 350, Ciba Spezialitatenchemie, Basel), bis-(3-(2H-benzotriazolyl)-2-hydroxy-5-tert-octyl)methane, (Tinuvin® 360, Ciba Spezialitatenchemie, Basel), (2-(4,6-diphenyl-1,3,5-triazin-2-yl)-5-(hexyloxy)phenol (Tinuvin® 1577, Ciba Spezialitätenchemie, Basel), and the benzophenones 2,4-dihydroxybenzophenone (Chimassorb® 22, Ciba Spezialitatenchemie, Basel) and 2-hydroxy-4-(octyloxy)benzophenone (Chimassorb® 81, Ciba, Basel), 2-propenoic acid, 2-cyano-3,3-diphenyl-, 2,2-bis[[(2-cyano-1-oxo-3,3-diphenyl-2-propenyl)oxy]methyl]-1,3-propanediyl ester (9CI) (Uvinul® 3030, BASF AG Ludwigshafen), 2-[2-hydroxy-4-(2-ethylhexyl)oxy]phenyl-4,6-di(4-phenyl)phenyl-1,3,5-triazine (CGX UVA 006, Ciba Spezialitätenchemie, Basel) or tetraethyl-2,2′-(1,4-phenylene dimethylidene)bismalonate (Hostavin® B-Cap, Clariant AG).

Mixtures of these ultraviolet absorbers can also be used.

There are no particular restrictions regarding the amount of ultraviolet absorber contained in the composition, provided that the desired absorption of UV radiation by the moulding produced from the composition is ensured and that the black impression is not adversely affected by the inherent colour of the UV absorber.

Component 1.7)

Heat stabilisers and process stabilisers in the base layer that are suitable according to the invention are phosphites and phosphonites and also phosphines. Examples are triphenylphosphite, diphenylalkylphosphite, phenyldialkylphosphite, tris(nonylphenyl)phosphite, trilaurylphosphite, trioctadecylphosphite, distearylpentaerythritol diphosphite, tris (2,4-di-tert-butylphenyl)phosphite, diisodecylpentaerythritol diphosphite, bis(2,4-di-tert-butylphenyepentaerythritol diphosphite, bis(2,4-dicumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)pentaerythritol diphosphite, bis(2,4,6-tris (tert-butylphenyl)pentaerythritol diphosphite, tristearylsorbitol triphosphite, tetrakis(2,4-di-tert-butylphenyl)-4,4′-biphenylene diphosphonite, 6-isooctyloxy-2,4,8,10-tetra-tert-butyl-12H-dibenzo[d,g]-1,3,2-dioxaphosphocine, bis(2,4-di-tert-butyl-6-methylphenyl)methylphosphite, bis(2,4-di-tert-butyl-6-methylphenyl)ethylphosphite, 6-fluoro-2,4,8,10-tetra-tert-butyl-12-methyl-dibenzo[d,g]-1,3,2-dioxaphosphocine,2,2′,2″-nitrilo-[triethyltris (3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane, bis(2,6-di-tert-butyl-4-methylphenyl)pentaerythritol diphosphite, triphenylphosphine (TPP), trialkylphenylphosphine, bisdiphenylphosphinoethane or a trinaphthylphosphine. Triphenylphosphine (TPP), Irgafos® 168 (tris(2,4-di-tert-butylphenyl)phosphite) and tris(nonylphenyl)phosphite or mixtures thereof are preferably used in particular.

Phenolic antioxidants such as alkylated monophenols, alkylated thioalkyl phenols, hydroquinones and alkylated hydroquinones can also be used. Irganox® 1010 (pentaerythritol-3-(4-hydroxy-3,5-di-tert-butylphenyl)propionate; CAS: 6683-19-8) and Irganox 1076® (2,6-di-tert-butyl-4-(octadecanoxycarbonylethyl)phenol) are particularly preferably used.

In a special embodiment of the present invention the phosphine compounds according to the invention are used together with a phosphite or a phenolic antioxidant or a mixture of these last two compounds.

Component 1.8)

The base layer optionally contains 0.0 wt. % to 5.0 wt. %, preferably 0.01 wt. % to 1.00 wt. % of at least one further additive. The further additives are conventional polymer additives such as are described for example in EP-A 0 839 623, WO-A 96/15102, EP-A 0 500 496 or “Plastics Additives Handbook”, Hans Zweifel, 5th Edition 2000, Hanser Verlag, Munich, such as flame retardants or flow promoters. The base layer components that have already been specified are expressly excluded in this connection.

The amounts specified above relate in each case to the total polymer composition.

The composition must be able to be processed under the conventional temperatures for thermoplastics, i.e. at temperatures above 300° C., such as 350° C. for example, without undergoing any marked change in optical properties such as for example deep gloss or in mechanical properties during processing.

The polymer composition for the base layer according to the invention containing the aforementioned components is produced using common incorporation methods by combining, mixing and homogenising, wherein homogenisation in particular preferably takes place in the melt under the action of shear forces. Combining and mixing optionally takes place prior to melt homogenisation, using pre-mixed powders.

Pre-mixes produced from solutions of the mixture components in suitable solvents can also be used, wherein homogenisation optionally takes place in solution and then the solvent is removed.

The components of the composition according to the invention can be incorporated in particular by known methods such as inter alia as a masterbatch.

The use of masterbatches and of dry blends or compacted pre-mixes is suitable in particular for incorporating the aforementioned components. All aforementioned components can optionally be pre-mixed. Alternatively, however, pre-mixes of the components are possible. In all cases, in the interests of improved metering in the production of the thermoplastic polymer compositions, the aforementioned component pre-mixes are preferably made up with the powdered polymer component so as to obtain total volumes that can easily be handled.

In a particular embodiment the aforementioned components can be mixed to form a masterbatch, wherein premixing preferably takes place in the melt under the action of shear forces (for example in a compounder or twin-screw extruder). This method offers the advantage that the components are distributed better in the polymer matrix. The thermoplastic polymer that is also the main component of the ultimate total polymer composition is preferably used as the polymer matrix for production of the masterbatch.

In this connection the composition can be mixed and homogenised in conventional devices such as extruders (for example twin-screw extruders), compounders, Brabender or Banbury mills, and then extruded. Following extrusion the extrudate can be cooled and shredded. Individual components can also be pre-mixed and then the remaining starting materials added individually and/or likewise in a mixture.

In a particular embodiment the method for producing weathering-resistant multilayer plastic moulded parts having a deep-gloss appearance consists of the following steps:

1. Producing a substrate material (component A) containing polycarbonate with an MVR of 7 cm³/(10 min) to 25 cm³/(10 min), preferably 9 to 21 cm³/(10 min) according to ISO 1133 (at 300° C. and under a 1.2 kg load) and containing the colouring agent combination according to the invention, optionally a heat stabiliser, preferably triphenylphosphine in particular, optionally a release agent and optionally a UV stabiliser.

2. Producing a moulded part from component B in a special frame geometry. The injection moulding parameters need to be optimised accordingly in order to achieve a high surface quality. It is therefore preferable to operate at high mould temperatures.

3. Flow-coating the moulded part with a primer solution containing

a) organic binder promoting adhesion between the polycarbonate and a polysiloxane-based lacquer

b) at least one UV absorber

c) an alcohol-based solvent

Allowing the solvent to evaporate off from the component for 10 to 60 min at room temperature then curing for 5 min to 60 min at 100-135° C.

4. Flow-coating the moulded part with a siloxane lacquer containing

a) organosilicone compounds of formula RₙSiX₄₋ₙ (where n is 1 to 4), in which R denotes aliphatic C1 to C10 radicals, preferably methyl, ethyl, propyl, isopropyl, butyl and isobutyl radicals, and also aryl radicals, preferably phenyl, and substituted aryl radicals, and X denotes H, aliphatic C1 to C10 radicals, preferably methyl, ethyl, propyl, isopropyl, butyl and isobutyl radicals, and also aryl radicals, preferably phenyl, substituted aryl radicals, OH, C1 or partial condensates thereof

b) inorganic fine-particle compound, preferably SiO₂

c) an alcohol-based solvent

d) at least one UV absorber

Allowing the solvent to evaporate off from the component for 10 to 60 min at room temperature then curing for 10 min to 120 min at 100-140° C.

The polymer compositions according to the invention can be processed into products or mouldings, by for example first extruding the polymer compositions into granules as described and then processing these granules by suitable methods into various products or mouldings in a known manner.

In this connection the compositions according to the invention can be converted into products, mouldings or moulded objects by hot pressing, spinning, blow moulding, thermoforming, extrusion or injection moulding. Injection moulding or injection-compression moulding is preferred.

Injection moulding methods are known to the person skilled in the art and are described for example in “Handbuch Spritzgiessen”, Friedrich Johannnaber/Walter Michaeli, Munich; Vienna: Hanser, 2001, ISBN 3-446-15632-1 or “Anleitung zum Bau von Spritzgiesswerkzeugen”, Menges/Michaeli/Mohren, Munich; Vienna: Hanser, 1999, ISBN 3-446-21258-2.

Extrusion methods are known to the person skilled in the art and are described in respect of coextrusion for example inter alia in EP-A 0 110 221, EP-A 0 110 238 and EP-A 0 716 919. For details of the adapter and nozzle method see Johannaber/Ast: “Kunststoff-Maschinenftihrer”, Hanser Verlag, 2000 and in Gesellschaft Kunststofftechnik: “Coextrudierte Folien und Platten: Zukunftsperspektiven, Anforderungen, Anlagen und Herstellung, Qualitatssicherung”, VDI-Verlag, 1990.

The coating can be produced by various methods. For example, a coating can be applied by various vapour deposition methods, for example by electron beam methods, resistance heating and by plasma deposition or various sputtering methods, such as high-frequency sputtering, magnetron sputtering, ion-beam sputtering, etc., ion plating by DC, RF, HCD methods, reactive ion plating, etc., or chemical vapour deposition.

Thus, in addition to the aforementioned methods, various methods are known for producing a scratch-resistant coating on plastic articles. For example, lacquers based on epoxy, acrylic, polysiloxane, colloidal silica gel or inorganic/organic (hybrid systems) can be used. These systems can be applied by dipping, spin coating, spraying or flow coating, for example. Curing can take place thermally or by UV irradiation. Single-layer or multilayer systems can be used. The scratch-resistant coating can be applied for example directly or after preparing the substrate surface with a primer. Furthermore, a scratch-resistant coating can be applied by means of plasma-assisted polymerisation methods, e.g. via an SiO₂ plasma. Anti-fogging or non-reflective coatings can likewise be produced by plasma methods. It is also possible to apply a scratch-resistant coating to the resulting moulding using certain injection moulding methods, such as for example back moulding of surface-treated films. Various additives, such as for example UV absorbers, derived for example from triazoles or triazines, can be present in the scratch-resistant layer. IR absorbers of an organic or inorganic nature can also be included. These additives can be contained in the scratch-resistant lacquer itself or in the primer layer. The thickness of the scratch-resistant layer is 1-20 μm, preferably 2-15 μm. Below 1 μm the resistance of the scratch-resistant layer is insufficient. Above 20 μm cracking often occurs in the lacquer.

For polycarbonates a primer containing UV absorbers is preferably used to improve the adhesion of the scratch-resistant lacquer. The primer can contain further stabilisers such as for example HALS systems (stabilisers based on sterically hindered amines), adhesion promoters, flow control agents. The individual resin can be selected from a large number of materials and is described for example in Ullmann's Encylopedia of Industrial Chemistry, 5^{th} Edition, Vol. A18, pp. 368-426, VCH, Weinheim 1991. Polyacrylates, polyurethanes, phenol-based, melamine-based, epoxy and alkyd systems or mixtures of these systems can be used. The resin is mostly dissolved in suitable solvents—frequently in alcohols. Depending on the chosen resin, curing can take place at room temperature or at elevated temperatures. Temperatures of between 50° C. and 130° C. are preferably used—frequently after a majority of the solvent has been temporarily removed at room temperature. Commercially available systems are for example SHP470, SHP470FT and SHP401 from Momentive Performance Materials. Such coatings are described for example in U.S. Pat. No. 6,350,512 B1, U.S. Pat. No. 5,869,185, EP 1308084, WO 2006/108520.

Scratch-resistant lacquers (hard coats) are preferably synthesised from siloxanes and preferably contain UV absorbers. They are preferably applied by dipping or flow coating. Curing takes place at temperatures from 50° C. to 130° C. Commercially available systems are for example AS4000, SHC5020 and AS4700 (CAS: 857052-28-9) from Momentive Performance Materials. Such systems are described for example in U.S. Pat. No. 5,041,313, DE 3121385, U.S. Pat. No. 5,391,795, WO 2008/109072. The synthesis of these materials mostly takes place by condensation of alkoxy and/or alkyl alkoxy silanes with acid or base catalysis. Nanoparticles can optionally be incorporated. Preferred solvents are alcohols such as butanol, isopropanol, methanol, ethanol and mixtures thereof.

Instead of primer/scratch-resistant coating combinations, one-component hybrid systems can be used. These are described for example in EP0570165 or WO 2008/071363 or DE 2804283. Commercially available hybrid systems are available for example under the names PHC587 or UVHC 3000 from Momentive Performance Materials.

An adhesion-promoting UV protective primer based on polymethyl methacrylate and containing 1-methoxy-2-propanol and diacetone alcohol as solvents and a UV absorber combination containing dibenzoyl resorcinol and a triazine derivative is preferably used in particular as the primer. The top coat is in particular preferably a polysiloxane top coat comprising a sol-gel condensate consisting of methyl trimethylsilane with silica sol and containing a silylated UV absorber.

In a particularly preferred method the lacquer is applied by flow coating, since this method leads to coated parts having a high optical quality.

Flow coating can be performed manually using a hose or suitable coating head or automatically in a continuous process using flow-coating robots, optionally with flat film dies.

The components can be coated either in a suspended position or stored in an appropriate product carrier.

In the case of larger and/or 3D components, the part to be coated is suspended or placed in a suitable product carrier.

Small parts can also be coated by hand. In this case the liquid primer or lacquer solution for coating is poured over the sheet in a longitudinal direction starting from the top edge of the part whilst at the same time the starting point of the lacquer on the sheet is directed from left to right across the width of the sheet. The lacquered sheets are suspended vertically from a gripper in accordance with the individual manufacturer's specifications to allow the solvent to evaporate off and the sheets to cure.

The multilayer bodies according to the invention can be particularly preferably used as frames for window modules for cars, rail vehicles and aircraft. Other frame parts are also preferred.

### EXAMPLES

The invention is described in more detail below by reference to embodiment examples, wherein the determination methods described here are used for all corresponding parameters in the present invention unless otherwise specified.

Melt Volume-Flow Rate:

The melt volume-flow rate (MVR) is determined in accordance with ISO 1133 (at 300° C.; 1.2 kg).

Light Transmission (Ty):

The transmission measurements were carried out using a Lambda 900 spectral photometer from Perkin Elmer with a photometer sphere in accordance with ISO 13468-2 (i.e. overall transmission determined by measuring the diffuse transmission and direct transmission).

Bleeding Characteristics/Lacquering Ability:

The bleeding characteristics are determined by means of a test in which a lacquer solution that is suitable for polycarbonate is applied to the granules.

10 g of granules in 90 g of paint solvent (diacetone alcohol/2-methoxypropanol (15% wt. %/85 wt. %) are stirred in an Erlenmeyer flask. After varying times an amount (approx. 2 ml) is removed from the slowly colouring lacquer solution and introduced into a glass cell (1 cm coating thickness). The cell is measured on the PE Lambda 900 in transmission in front of the photometer sphere and the yellowness index (YI) for light type D 65 and 10° standard observer is determined by measuring the colour coordinates (CIE) and calculated in accordance with ASTM E313. The measured value for the pure paint solvent (diacetone alcohol/2-methoxypropanol (15% wt. %/85 wt. %) is deducted in each case from the measured value for the coloured lacquer solution.

Materials for Producing the Specimens:
Linear bisphenol-A polycarbonate with phenol-based terminal groups and a melt volume-flow rate (MVR) of 6 cm³/10 min, measured at 300° C. under a 1.2 kg load in accordance with ISO 1033), referred to below as PC 1.
Linear bisphenol-A polycarbonate with phenol-based terminal groups and an MVR of 12.5 cm³/10 min, measured at 300° C. under a 1.2 kg load in accordance with ISO 1033), referred to below as PC 2. PC 2 also contains an additive mixture consisting of release agent, heat stabiliser and UV stabiliser. Pentaerythritol tetrastearate (CAS 115-83-3) is used as the release agent, triphenylphosphine (CAS 603-35-0) as the heat stabiliser and Tinuvin® 329 (CAS 3147-75-9) as the UV stabiliser.
Black Pearls® 800 (CAS no. 1333-86-4) from Cabot Corp. are used as the nanoscale carbon black (particle size approx. 17 nm).

Colouring Agents
The product from 1 (all R═H, see below) is used as the colouring agent of formula (1a, 1b).
The product from II (all R═H, see below) is used as the colouring agent of formula (2a, 2b).
Macrolex Violet B (Solvent Violet 13, CAS no. 81-48-1) from Lanxess AG, Leverkusen, is used as the colouring agent of formula (3).

I) Production of a 1:1 mixture (wt. %) of (1a) and (1b):

5.62 g (0.025 mol) of benzene-1,2,4,5-tetracarboxylic acid dianhydride and 7.99 g (0.05 mol) of 1,8-diaminonaphthalene are placed in 75 ml of n-ethylpyrrolidone at room temperature and slowly heated to 150° C. The mixture is stirred at this temperature for 5 hours. After cooling, 125 ml of water are added and the precipitate formed is filtered off. The precipitate is then suspended repeatedly in water and washed in this way. The precipitate is dried under high vacuum at 80° C. A mixture of 50 ml of glacial acetic acid and 25 ml of acetic anhydride is added to the dried precipitate. The mixture is refluxed for 4 hours. After cooling, the reaction mixture is poured into 500 ml of water. The precipitate is filtered off, washed with water and dried under high vacuum at 80° C. 12.5 g of a lilac-coloured powder are obtained.

II) Production of a 1:1 mixture (wt. %) of (2a) and (2b):

6.71 g (0.025 mol) of naphthalene-1,4,5,8-tetracarboxylic acid dianhydride and 7.99 g (0.05 mol) of 1,8-diaminonaphthalene are placed in 75 ml of n-ethylpyrrolidone at room temperature and slowly heated to 150° C. The mixture is stirred at this temperature for 5 hours. After cooling, 152 ml of water are added and the precipitate formed is filtered off. The precipitate is then suspended repeatedly in water and washed in this way. The precipitate is dried under high vacuum at 80° C. A mixture of 50 ml of glacial acetic acid and 25 ml of acetic anhydride is added to the dried precipitate. The mixture is refluxed for 4 hours. After cooling, the reaction mixture is poured into 125 ml of water. The precipitate is filtered off, washed with hot water and dried under high vacuum at 80° C. 13.7 g of a lilac-coloured powder are obtained.

Production of the Thermoplastic Polymer Composition by Compounding:

Compounding of the additives was carried out in a twin-screw extruder supplied by KraussMaffei Berstorff, model ZE25, at a housing temperature of 260° C. and a compound temperature of 270° C. and at a speed of 100 rpm, with a throughput of 10 kg/h and the amounts of components as specified in the examples. To improve mixing, a dry blend of PC 1 (10 wt. % dry blend relative to the total composition) containing the additional components listed below is prepared first. This dry blend is added to PC 2 during compounding.

Production of the Specimens:

The granules are dried under vacuum at 120° C. for 3 hours and then processed in an Arburg 370 injection moulding machine with a size 25 injection unit at a compound temperature of 300° C. and a mould temperature of 90° C. to form optically round sheets having a diameter of 80 mm and a thickness of 2.0 mm.

### Example 1

### Comparative Example

A polymer composition containing the amounts of the following
components as described above is produced by compounding:

| | |
|---|---|
| Macrolex Violet B (colouring agent for | 0.20 wt. % |
| comparative examples): | |
| Black Pearls ® 800 (component b)): | 0.02 wt. % |

Specimen sheets and granules are prepared as above.

### Example 2

### According to the Invention

A polymer composition containing the amounts of the following
components as described above is produced by compounding:

| | |
|---|---|
| 1:1 mixture (wt. %) of (1a) and (1b) (component a)): | 0.10 wt. % |
| 1:1 mixture (wt. %) of (2a) and (2b) (component a)): | 0.10 wt. % |
| Specimen sheets and granules are prepared as above. | |

Light transmission measurement:
The specimen sheets from examples 1 and 2 have a light
transmission of less than 0.1%.

Visual Inspection:

The sample sheets from examples 1 and 2 are visually inspected. They have a defect-free surface and an adequate black impression.

TABLE 1
Granule bleeding test (as described above)

| Extraction | | Y1 example 1 | |
|---|---|---|---|
| time | | (comparison) | Y1 example 2 |
| 0 | min | 0 | 0 |
| 30 | min | −6.8 | −2.6 |
| 60 | min | −11.6 | −4.5 |
| 120 | min | −20.4 | −7.4 |
| 180 | min | −29.9 | −9.2 |
| 270 | min | −41.8 | −11.7 |
| 24 | h | −113.3 | −28.6 |

It is clear that in the comparative material, despite the use of carbon black, the lacquer solution is coloured significantly more strongly than is the case with the granules according to the invention. With mouldings having a significantly smaller surface area than granules there is no risk of bleeding when the composition according to the invention is used, whereas the risk of colouring of the lacquer solution does exist with the comparative material.

1.-14. (canceled)

15. A multilayer body comprising:
1) a base layer comprising
at least one thermoplastic,
at least one colouring agent selected from the group consisting of structures 1a, 1b: 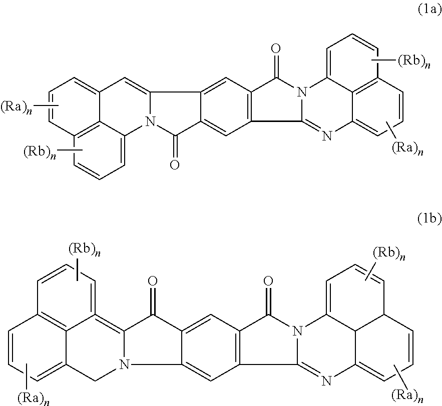
in which
Ra and Rb independently of each other denote a linear or branched alkyl radical, or halogen;
n independently of each R denotes a natural number between 0 and 3, the radical being hydrogen in the case of n=0, and 2a, 2b: 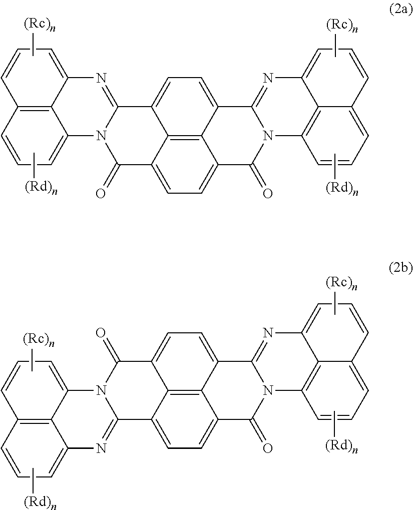
in which
Rc and Rd independently of each other denote a linear or branched alkyl radical, or halogen;
n independently of each R denotes a natural number between 0 and 3, the radical being hydrogen in the case of n=0;
having a light transmission of less than 1%, and
2) at least on one side of the base layer a polysiloxane-based scratch-resistant coating with a thickness from 2 to 15 μm, comprising at least one UV absorber.

16. The multilayer body according to claim 15, wherein the colouring agent of structures (1a), (1b), (2a) and (2b) are each used individually in concentrations from 0.05 wt. % to 0.50 wt. %.

17. The multilayer body according to claim 15, wherein a combination of colouring agents of structures (1a), (1b), (2a) and (2b) is used.

18. The multilayer body according to claim 15, wherein the base layer contains a combination of colouring agents (1a)/(1b) and/or (2a)/(2b) and at least one further colouring agent selected from the group consisting of 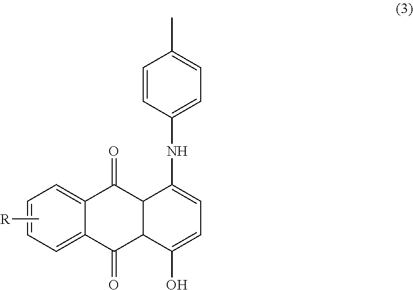
in which
R is selected from the group consisting of H and p-methyl phenylamine radical; 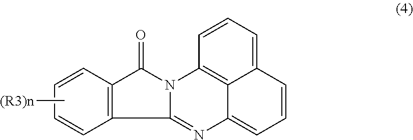
in which
R3 is halogen;
n=4; 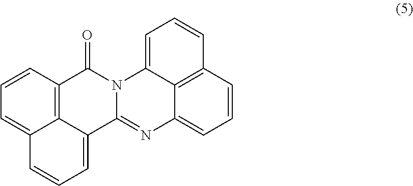 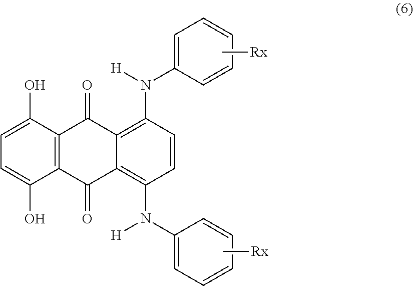
in which Rx and Ry denote n-butyl, tert-butyl or methyl, 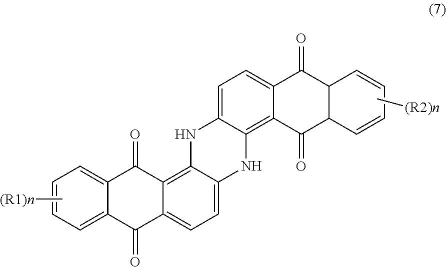
in which
R1 and R2 independently of each other denote a linear or branched alkyl radical, or halogen;
n denotes a natural number between 0 and 4, and 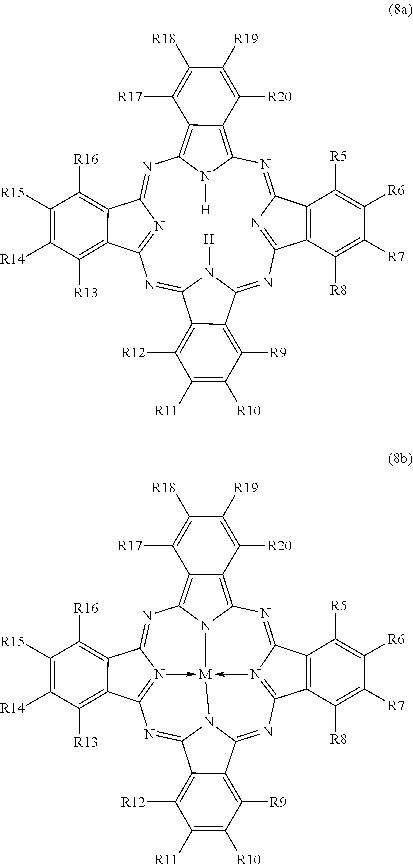
in which
the radicals R(5-20) are in each case independently of one another hydrogen, methyl, ethyl, propyl, isopropyl, butyl, isobutyl, tert-butyl, pentyl, neopentyl, hexyl, thexyl, fluorine, chlorine, bromine, sulfone or CN, and
M is selected from the group comprising aluminium, nickel, cobalt, iron, zinc, copper and manganese.

19. The multilayer body according to claim 15, wherein the base layer contains carbon black in a concentration of less than 0.03 wt. %.

20. The multilayer body according to claim 15, wherein an adhesion-promoting layer having a thickness from 0.3 to 8 μm and containing at least one UV absorber is additionally arranged on the base layer between the base layer and the scratch-resistant layer.

21. The multilayer body according to claim 15, wherein the thermoplastic is selected from the group comprising polycarbonate and polycarbonate blends having a melt volume-flow rate from 6 cm³/(10 min) to 25 cm³/(10 min).

22. The multilayer body according to claim 15, wherein the base layer contains a heat stabiliser.

23. The multilayer body according to claim 15, wherein a scratch-resistant layer and optionally an adhesion-promoting layer is applied to both sides of the base layer.

24. The multilayer body according to claim 15, wherein the scratch-resistant layer is a polysiloxane lacquer.

25. A method for producing a multilayer body having a deep-gloss appearance, comprising the following steps:
producing the colouring agents 1a, 1b, 2a, 2b,
producing a compound containing the components of the base layer according to claim 15,
producing a moulded part from the compound,
coating the moulded part with a scratch-resistant layer in a single-stage coating process.

26. The method according to claim 25, wherein a primer layer is applied before the moulded part is coated with the scratch-resistant layer.

27. The method according to claim 25, wherein the steps are performed in the specified order.

28. A method comprising utilizing the multilayer body of claim 15 as an exterior vehicle part, interior vehicle part or for frame parts for glass or polycarbonate glazing systems.
